(19) United States
(12) Patent Application Publication
(10) Pub. No.: US 2019/0171152 A1
(43) Pub. Date: Jun. 6, 2019

(54) PAPER SENSOR DEVICE

(71) Applicant: SHARP KABUSHIKI KAISHA, Osaka (JP)

(72) Inventor: YUSUKE SAKAKIBARA, Osaka (JP)

(21) Appl. No.: 16/203,257

(22) Filed: Nov. 28, 2018

(30) Foreign Application Priority Data
Dec. 1, 2017 (JP) 2017-231894

(51) Int. Cl. G03G 15/00; B41J 11/00; B65H 5/06; G01N 21/86

(52) U.S. Cl. CPC G03G 15/602; B41J 11/0095; G01N 2021/8663; B65H 5/06; G01N 21/86; G03G 15/607

(57) ABSTRACT

The present invention has a purpose of providing a paper sensor device capable of measuring measurement light with high precision to detect a paper property with high precision without adding to printing time. A paper sensor device includes: a light-emitter that emits emission light; a photodetector that receives emission light in a first state and receives light transmitted through a sheet of paper in a second state; and a transporting unit that transports the sheet of paper. The transporting unit, including a transport roller and a paper guide, transports the sheet of paper while sandwiching the sheet of paper between the transport roller and the paper guide. The light-emitter is embedded in the transport roller. The photodetector is disposed on the back of the paper guide to receive light via a window.

### BACKGROUND OF THE INVENTION

### Field of the Invention

The present disclosure relates to paper sensor devices and image-forming devices including paper sensor devices.

### Related Art

Various types of paper (recording paper) such as high-quality paper, recycled paper, and coated paper, as well as heavy and thin paper, are used in image-forming devices such as copying machines, printers, facsimile machines, and multifunction printers having these functions. Damp paper may also be used in some operating environments.

It is necessary to properly set image-forming conditions such as transfer current, fusing pressure, fusing temperature, and fusing time in accordance with the type, water content ratio, and/or other properties of the paper in order to improve the quality of the image formed by the image-forming device. For these purposes, image-forming devices have been developed that are equipped with sensors that detect (determine) paper properties.

As an example, Japanese Unexamined Patent Application Publication, Tokukai, No. 2006-53398 (“Patent Document 1”) discloses an image-forming device including a sensor that: projects, onto paper, light having such a wavelength that water can absorb the light; and calculates the water content of the paper on the basis of light reflected off the paper.

Japanese Unexamined Patent Application Publication, Tokukai, No. 2007-145590 (“Patent Document 2”) discloses a paper sensor device that: projects light onto paper and recognizes the type of the paper on the basis of light reflected off the paper. The paper sensor device includes, in a light projection target position, a pressing plate that prevents protrusion of paper. Light is projected onto the pressing plate with no paper between the pressing plate and the paper sensor device, so that the sensor can be calibrated on the basis of light reflected off the paper.

Both Patent Documents 1 and 2 deal with measurement of reflection of light projected onto a sheet of paper. Some other documents deal with measurement of transmission of light projected onto a sheet of paper. The term, “measurement light,” may be used in the following description to collectively refer to the light that is projected onto, and either reflected off or transmitted through, a sheet of paper.

### SUMMARY OF THE INVENTION

### Problems to be Solved by the Invention

In Patent Document 1, light is projected onto a sheet of paper being transported to measure the light reflected off the sheet. Patent Document 1, however, is short of considering adverse effects of, for example, flapping, tilting, and warping of the sheet during transport. Precision of measurement of reflected light therefore falls, and the water content is not calculated with high precision. Patent Document 1 is capable of maintaining high levels of measurement precision if the sheet is stopped during measurement. This approach, however, leads to another problem that it takes more time to complete printing in response to a print command input from the user (hereinafter, “printing time”).

Meanwhile, in Patent Document 2, the pressing plate is capable of preventing protrusion of paper. If the sheet of paper warps toward a paper sensor device, however, precision of measurement falls similarly, and the type of the sheet is not recognized with high precision.

The present disclosure, made in view of these problems, has an object to provide a paper sensor device capable of measuring measurement light with high precision to detect a paper property with high precision without adding to printing time and also to provide an image-forming device including such a paper sensor device.

### Solution to the Problems

To address the problems, the present disclosure, in an aspect thereof, is directed to a paper sensor device including: a light-emitter; a photodetector configured to receive measurement light projected by the light-emitter and then either transmitted or reflected by a sheet of paper, the paper sensor device detecting a paper property based on the measurement light; and a transporting unit configured to transport the sheet of paper while sandwiching the sheet of paper between a transport roller and an opposing member, either or both of the transport roller and the opposing member having a window on a sandwiching face thereof where the sheet of paper is sandwiched, wherein: the light-emitter projects light via the window(s) onto a sandwiched portion of the sheet of paper being transported; and the photodetector receives the measurement light via the window(s).

### Advantageous Effects of the Invention

This arrangement achieves the advantage of providing a paper sensor device capable of measuring measurement light with high precision to detect a paper property with high precision without adding to printing time.

### BRIEF DESCRIPTION OF DRAWINGS

FIG. 1 is a schematic illustration of a paper sensor device in accordance with Embodiment 1, (a) and (b) of FIG. 1 representing a first state and a second state of the paper sensor device respectively.

FIG. 2 is a schematic perspective view of a paper sensor device in accordance with Embodiment 1.

FIG. 3 is a block diagram of a configuration of major components of an image-forming device in accordance with Embodiment 1, the image-forming device including a paper sensor device in accordance with Embodiment 1.

FIG. 4 is a circuit diagram of an example configuration of an amplification circuit 14 provided in an image-forming device in accordance with Embodiment 1.

FIG. 5 is a flow chart for a printing process in an image-forming device in accordance with Embodiment 1.

FIG. 6 is a block diagram of a configuration of major components of an image-forming device in accordance with Variation Example 1 of Embodiment 1.

FIG. 7 is a flow chart for a printing process in an image-forming device in accordance with Embodiment 2.

FIG. 8 is a schematic illustration of a paper sensor device in accordance with Embodiment 3, (a) and (b) of FIG. 8 representing a first state and a second state of the paper sensor device respectively.

FIG. 9 is a schematic perspective view of a paper sensor device in accordance with Embodiment 3.

FIG. 10 is a block diagram of a configuration of major components of an image-forming device in accordance with Embodiment 3.

FIG. 11 is a schematic illustration of a paper sensor device in accordance with Embodiment 4, (a) and (b) of FIG. 11 representing a first state and a second state of the paper sensor device respectively.

FIG. 12 is a schematic illustration of a paper sensor device in accordance with Embodiment 5, (a) and (b) of FIG. 12 representing a first state and a second state of the paper sensor device respectively.

FIG. 13 is a schematic perspective view of a paper sensor device in accordance with Embodiment 5.

FIG. 14 is a schematic illustration of a paper sensor device in accordance with Embodiment 5, (a) and (b) of FIG. 14 representing a first state and a second state of the paper sensor device respectively.

FIG. 15 is a schematic perspective view of two transport rollers provided in a paper sensor device in accordance with Embodiment 5.

FIG. 16 is a block diagram of a configuration of major components of an image-forming device in accordance with Embodiment 5.

FIG. 17 is a diagram of a common example structure of image-forming devices including a paper sensor device in accordance with Embodiments 1 to 6.

### DESCRIPTION OF EMBODIMENTS

### Embodiment 1

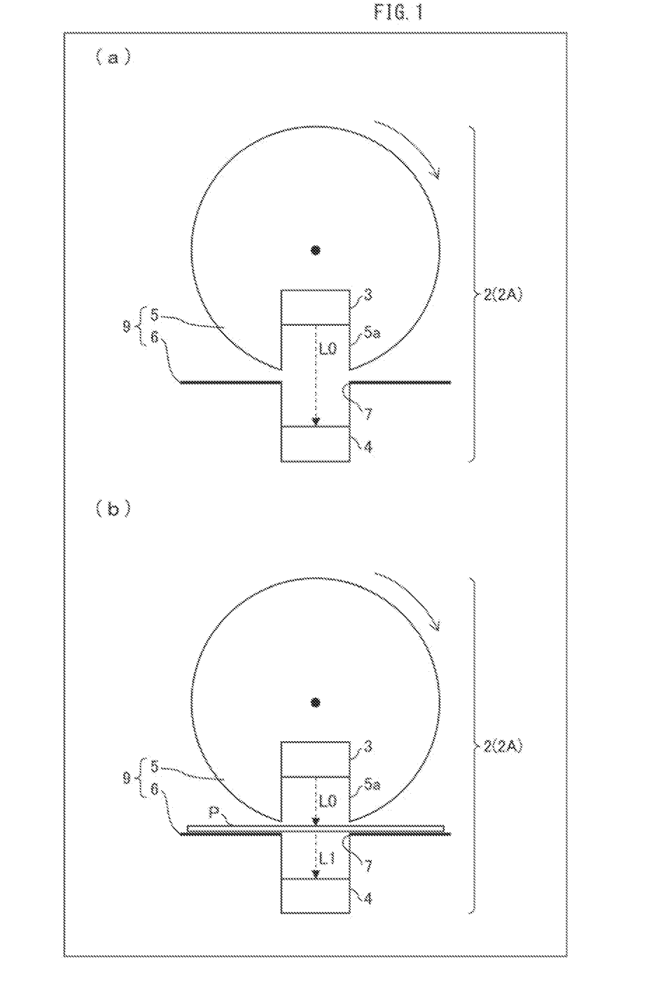

The following will describe an embodiment of the present disclosure in reference to FIGS. 1 to 6 and 17. The present embodiment describes an image-forming device that is included in a copying machine, printer, facsimile machine, or multifunction printer having these functions in order to detect (determine) the thickness (grammage) of a sheet of paper as a paper property and set printing conditions on the basis of the detection.

### Overview of Image-forming Device 100

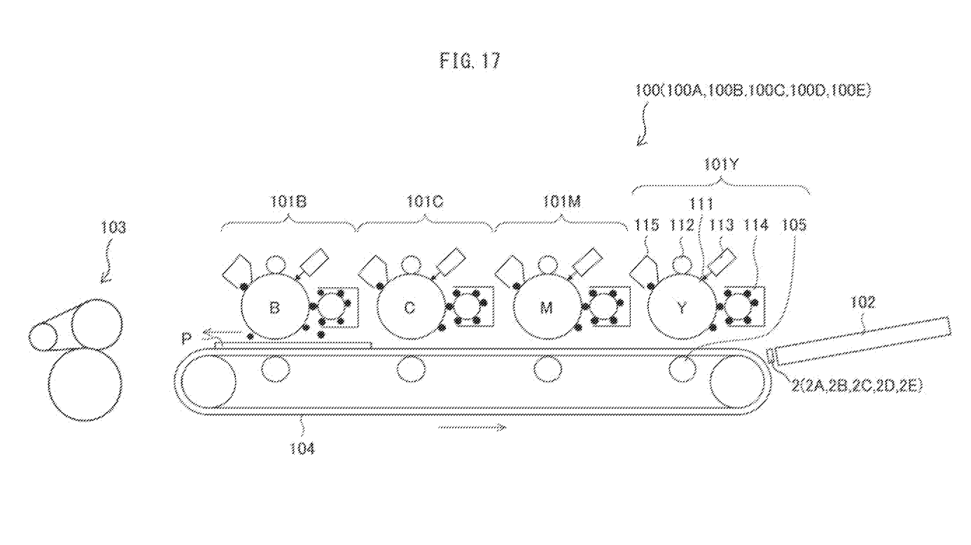

FIG. 17 is a diagram of an example structure of an image-forming device 100 in which there is provided a paper sensor device 2 in accordance with the present embodiment. FIG. 17 also represents image-forming devices 100A to 100E in which there are provided paper sensor devices 2A to 2E (detailed later) respectively in accordance with Embodiments 2 to 6.

Referring to FIG. 17, the image-forming device 100 includes a yellow-image-forming station 101Y, a magenta-image-forming station 101M, a cyan-image-forming station 101C, and a black-image-forming station 101B.

The four image-forming stations 101Y to 101B are disposed along a transport path of a sheet of paper P between a paper feeder 102 and a fuser 103. Under the four image-forming stations 101Y to 101B is there disposed an endless transport belt 104 for electrostatically attracting and transporting the sheet of paper P thereon. There are provided four transfer rollers 105, one for each of the four image-forming stations 101Y to 101B, inside the transport belt 104.

The four image-forming stations 101Y to 101B have the same structure, and each of them includes a photoreceptor drum 111. Around each photoreceptor drum 111 are there provided a charge roller 112, an exposure device 113, a development device 114, a different one of the transfer rollers 105, and a cleaner device 115. Each development device 114 in the image-forming stations 101Y to 101B contains a developer that contains toner of an associated color.

The charge roller 112 uniformly charges the surface of the photoreceptor drum 111. The exposure device 113 exposes the surface of the photoreceptor drum 111 to light to form an electrostatic latent image. The development device 114 supplies toner to the electrostatic latent image to form a toner image. The transfer roller 105 applies a bias voltage (transfer voltage) from the backside of the transport belt 104 to transfer the toner age formed on the surface of the photoreceptor drum 111 onto the sheet of paper P transported by the transport belt 104. The cleaner device 115 collects residual toner from the surface of the photoreceptor drum 111.

The paper feeder 102 supplies sheets of paper P. The sheet of paper P may be, for example, high-quality paper, recycled paper, thin paper, heavy paper, or coated paper. The fuser 103 squeezes the sheet of paper P between a belt and a roller to apply suitable heat (fusing temperature) and pressure (fusing pressure) to dissolve toner and thereby fuse a toner image onto the sheet of paper P.

The sheet of paper P fed from the paper feeder 102 is attracted and transported on the transport belt 104 and passed below the four image-forming stations 101Y to 101B, during which the toner images formed by the image-forming stations 101Y to 101B are transferred one by one onto the sheet of paper P. The transferred toner images are fused on the sheet of paper P by the fuser 103.

In the image-forming device 100 structured as above, the paper sensor device 2 is disposed, for example, between the paper feeder 102 and the transport belt 104. FIG. 17 shows an electrophotographic printer, which may alternatively be an inkjet or another type of printer.

### Structure of Paper Sensor Device 2

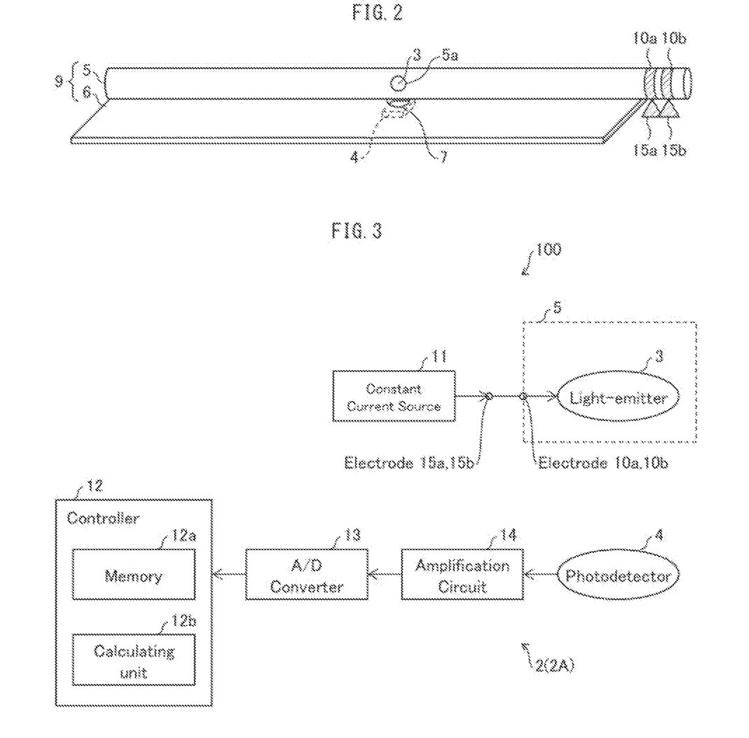

FIG. 1 is a schematic illustration of the paper sensor device 2 in accordance with the present embodiment, (a) and (b) of FIG. 1 representing a first state and a second state of the paper sensor device 2 respectively. The first state is a state where measurements are made on reference light. The second state is a state where light is projected onto a sheet of paper and measurements are made on measurement light. FIG. 2 is a schematic perspective view of the paper sensor device 2.

As shown in (a) and (b) of FIG. 1, the paper sensor device 2 includes a light-emitter 3, a photodetector 4, and a transporting unit 9. The light-emitter 3 projects light L0. The photodetector receives light L0 and L1 to measure the intensity (amount of light) of the received light. In the present embodiment, the photodetector 4 measures the intensity of transmitted light L1 that is part of light L0, projected onto the sheet of paper P by the light-emitter 3, that is transmitted by the sheet of paper P. A controller 12 (detailed later; see FIG. 3) then detects the thickness of the sheet of paper as a paper property on the basis of a result of the measurement.

The light-emitter 3 is a light-emitting element and may be, for example, an LED (light emitting diode). The light-emitter 3 is not necessarily an LED and may alternatively be, for example, another type of light source such as a laser beam source. In addition, the light-emitter 3 may be configured to only emit emission light L0 of a single particular wavelength and may be configured to concurrently emit emission light L0 of plural wavelengths.

The photodetector 4 is a light-receiving sensor (light-receiving element) and may be, for example, a photodiode. The photodetector 4 is not necessarily a photodiode and may alternatively be, for example, a phototransistor or a photo IC.

The transporting unit 9 includes a transport roller 5 and a paper guide 6 (opposing member). A sheet of paper is sandwiched between the transport roller 5 and the paper guide 6 during transport. The paper guide 6 is a guide for transporting the sheet of paper P and so arranged as to face the transport roller 5.

The transport roller 5 is disposed such that it can be moved up/down between an upper, retracted position and a lower, transport position by a moving mechanism (not shown). The transport roller 5 is separated from the paper guide 6 when there is no sheet of paper between the transport roller 5 and the paper guide 6. As a sheet of paper P arrives between the transport roller 5 and the paper guide 6, the transport roller 5 drops to sandwich the sheet of paper P between the transport roller 5 and the paper guide 6 for transport. The paper guide 6 is not necessarily fiat and may be curved.

In the present embodiment, the light-emitter 3 is disposed inside the transport roller 5, and the photodetector 4 is disposed on a face opposite the sandwiching face where a sheet of paper is sandwiched. The light-emitter 3 is disposed so as to be capable of projecting emission light L0 from the outer circumferential surface of the transport roller 5. To describe it in more detail, as shown in FIG. 2, there is provided a hole 5a in the transport roller 5 from its outer circumferential surface toward its center so that the light-emitter 3 can be disposed inside the hole 5a. The light-emitter 3 has a light-emitting face directed at the opening (window) of the hole 5a. Throughout the following description, the fixing of an element inside the solid transport roller 5 in this manner will be described as the “embedding” of the element.

The paper guide 6 has a window 7 enabling passage therethrough of (emission light) L0 (see (a) and (b) of FIG. 1) projected by the light-emitter 3 embedded in the transport roller 5. The photodetector 4 is disposed facing the window 7 in order to receive the light passing through the window 7. The window 7 needs only to transmit the wavelengths of the light emitted by the light-emitter 3. The window 7 may be either a mere hole formed in the paper guide 6 or a hole fitted with glass or a like transparent member. The hole 5a has an opening (window) structured similarly, possibly fitted with glass or a like transparent member.

As shown in (a) of FIG. 1, the first state of the paper sensor device 2 is defined as a state in which there exists no sheet of paper P between the light-emitter 3 and the photodetector 4 with the light-emitter 3 pointing in the direction of the photodetector 4 as a result of rotation of the transport roller 5. Meanwhile, as shown in (b) of FIG. 1, the second state of the paper sensor device 2 is defined as a state in which there exists a sheet of paper P between the light-emitter 3 and the photodetector 4 with the light-emitter 3 pointing in the direction of the photodetector 4 as a result of rotation of the transport roller 5.

In the first state, emission light L0 emitted by the light-emitter 3 strikes the photodetector 4 via the window 7, and the photodetector 4 receives this light as shown in (a) of FIG. 1. In contrast, in the second state, sonic of emission light L0 is absorbed by the sheet of paper P or scattered by the surface of the sheet of paper P, and the rest of the emission light, Which provides transmitted light L1, strikes the photodetector 4 via the window 7 as shown in (b) of FIG. 1. The photodetector 4 receives this light.

Referring to FIG. 2, the transport roller 5, configured in this manner, includes roller electrodes (first electrodes) 10a, 10b disposed at or near its ends. The roller electrodes 10a, 10b are connected to the light-emitter 3 by conductive wires inside the transport roller 5. The roller electrodes 10a, 10b are in contact with respective external electrodes (second electrodes) 15a, 15b provided outside the transport roller 5. The external electrodes 15a, 15b slide respectively on the roller electrodes 10a, 10b as a result of rotation of the transport roller 5. The external electrodes 15a, 15b are connected to a constant current source 11 (detailed later; see FIG. 3). This structure maintains the roller electrodes 10a, 10b in contact with the external electrodes 15a, 15b even when the transport roller 5 is rotating, to externally supply electric current to the light-emitter 3 (element) disposed inside the transport roller 5.

### Configuration of Major Components of Image-forming Device 100

FIG. 3 is a block diagram of a configuration of major components of the image-forming device 100, Referring to FIG. 3, the image-forming device 100 includes, for example, the constant current source 11, the controller 12, an A/D (analog/digital) converter 13, and an amplification circuit 14, as well as the light-emitter 3 and the photodetector 4 both of which are included in the paper sensor device 2.

The constant current source 11, in the present embodiment, outputs a constant current to the light-emitter 3 at all times so that the light-emitter 3 can emit light with a fixed intensity. Alternatively, the constant current source 11 may output a constant current so that the light-emitter 3 can emit light with a fixed intensity, only when the light-emitter 3 is turned to face the photodetector 4 as a result of rotation of the transport roller 5. As further alternatives, the constant current source 11 may be constructed from a constant-voltage power source connected in series with the light-emitter 3 and a fixed resistor and may be built around a constant-current IC.

The controller 12 controls the light-emitter 3, the photodetector 4, and the transporting unit 9. Controlling the transporting unit 9 is equivalent to controlling the transport of the sheet of paper P and the rotation of the transport roller 5. The controller 12 additionally determines a paper property (thickness in this example) of the sheet on the basis of a signal from the A/D converter 13 that indicates the intensity of the light received by the photodetector 4. The present embodiment is described taking the thickness (grammage) of the sheet as an exemplar paper property. Other examples include the brand name, water content ratio, and surface smoothness of the sheet. The controller 12 determines at least one of these properties. The controller 12 includes a memory 12a and a calculating unit 12b. The controller 12 may be built, for example, around a microcomputer.

The A/D converter 13 converts the output voltage of the amplification circuit 14 to a digital signal for output to the controller 12. If the controller 12 is a microcomputer, the A/D converter 13 may be, for example, an A/D converter that is a part of the microcomputer.

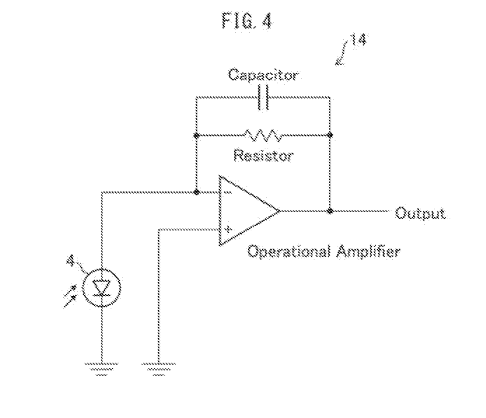

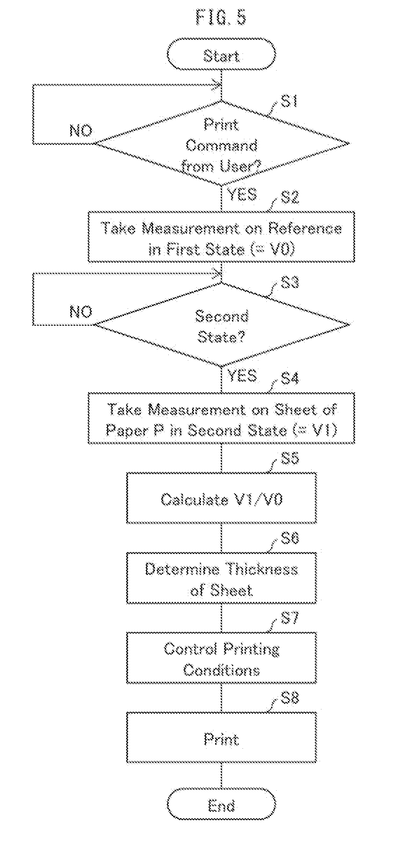

The amplification circuit 14 converts a photocurrent from the photodetector 4 (photodiode) to a voltage in proportion to the photocurrent for output to the A/D converter 13. Such an amplification circuit 14 can be built, for example, around an operational amplifier with a negative feedback resistor being connected as shown in FIG. 4. FIG. 4 is a circuit diagram of an example configuration of the amplification circuit 14.

The constant current source 11, the controller 12, the A/D converter 13, and the amplification circuit 14 may be included in the paper sensor device 2 or included in the image-forming device 100 separately from the paper sensor device 2. In the latter case, the functions of the controller 12 may be assigned to a control device in the image-forming device 100.

### Printing Process in Image-Forming Device 100

Next, referring to FIG. 5, the flow of a process will be described in which the thickness of the sheet as a paper property is determined and an image is printed in accordance with the determined thickness. FIG. 5 is a flow chart for a printing process in the image-forming device 100 in accordance with the present embodiment.

The controller 12 awaits an input of a print command from the user (S1). The controller 12 rotates the transport roller 5 in response to an input of a print command. When the light-emitter 3 points in the direction of the photodetector 4 (first state) before the sheet of paper P reaches the transport roller 5, a measurement is made on reference. During the measurement, the transport roller 5 may be stopped. Alternatively, a measurement may be made on reference when the light-emitter 3 has come to point in the direction of the photodetector 4 while the transport roller 5 is being rotated. Light L0 emitted by the light-emitter 3 is received (as reference light) by the photodetector 4 in the first state. The output of the photodetector 4 is converted to a voltage by the amplification circuit 14 and then to a digital value V0 by the A/D converter 13. The controller 12 stores V0 in the memory 12a.

Next, the controller 12 awaits the sheet of paper P arriving and the light-emitter 3 pointing in the direction of the photodetector 4 (second state) (S3). As the second state is reached, the controller 12 takes a measurement on the sheet of paper P (S4). In the second state, the photodetector 4 receives light L1 passing through the sheet of paper P for conversion to a voltage by the amplification circuit 14. The A/D converter 13 then outputs a digital value V1. The controller 12 stores V1 in the memory 12a.

Measurement may be performed only once, but preferably performed twice or more times on the sheet of paper P to obtain an average of measurements made on a plurality of portions of the sheet. More preferably, measurement may be performed every time the light-emitter 3 comes to point in the direction of the photodetector 4 while the transport roller 5 is rotating, in order to obtain an average of measurements as V1. These techniques would reduce errors that may occur in the measurement due to variations in thickness (paper property) from one portion to another in the transport direction of the single sheet of paper P.

The inventors of the present invention have observed that the sheet of paper P varies greatly in thickness from one portion to another that are separated by a distance less than 1 cm. It is therefore preferable to perform measurement on a plurality of portions of the sheet of paper P that are separated from each other by approximate intervals of 3 cm. In other words, the transport roller 5 preferably has a diameter of approximately 1 cm (a circumference of approximately 3 cm).

The calculating unit 12b in the controller 12 retrieves, from the memory 12a, reference V0 obtained by measurement in step S2 and measured value V1 obtained by measurement made on the sheet of paper P in step S4 to calculate a ratio V1/V0 (S5). The memory 12a in the controller 12 contains threshold values in advance on the basis of V1/V0 measurements made on various sheets of paper P. The manufacturer of the image-forming device 100 may, for example, prepare and store this data in the memory 12a in the form of a database. The calculating unit 12b compares these threshold values with the ratios V1/V0 calculated in step S5 to determine the thickness of the sheet of paper (S6). As an example, if V1/V0 is from 0 to 0.1, the paper is determined to be heavy paper; if V1/V0 is from 0.1 to 0.3, the paper is determined to be normal paper; if V1/V0 is from 0.3 to 0.5, the paper is determined to be thin paper; and if V1/V0 is from 0.5 to 1, it is determined that no sheet of paper P has arrived (due to paper jamming or another error).

The image-forming device 100 specifies image-forming (printing) conditions in accordance with this determination (S7) and forms (prints) an image on the sheet of paper P (S8). Examples of the image-forming conditions (printing conditions) specified by the controller 12 include the transfer current and voltage applied to transfer toner to the sheet of paper P, the transport speed of the sheet of paper P when the toner is fused onto the sheet of paper P (fusing time), and the temperature of the heating roller (fusing temperature) and the pressure of the pressure roller (fusing pressure) when the sheet of paper P is squeezed in the fuser 103. When the sheet of paper P is heavy paper, the controller 12 increases the fusing temperature or time over a thin sheet of paper P.

The smoothness, brand name, and other properties of the sheet of paper can be recognized if the memory 12a contains, in the form of a database, threshold values for determining such properties of the sheet of paper on the basis of V1/V0. For example, if the sheet of paper P has a rough surface, the controller 12 increases transfer current and fusing pressure over paper with a flat and smooth surface.

V0 (reference light) may not be measured repeatedly. For example, V0 may be measured only once during the manufacture of the image-forming device 100, and the measurement be stored for later use. As another alternative, V0 may not at all be measured. A database of values of V1 only, instead of V1/V0, may be prepared so that a paper property can be determined only from a V1 value.

### Advantages

The configuration described above measures a property of a portion (“measuring portion”), of the sheet of paper P, that is sandwiched between the transport roller 5 and the paper guide 6 (sandwiched portion). The configuration can therefore reduce adverse effects of flapping, tilting, and warping of the sheet of paper P and measure the intensity of transmitted light L1 (measurement light) with high precision.

The incorporation of the paper sensor device 2 in the image-forming device 100 enables automation of the process from the measurement of the intensity of transmitted light to determine a paper property of the sheet of paper P to the specification of image-forming conditions and the formation of an image. The configuration also shares the transport roller 5 with the image-forming device 100, thereby allowing for reduction in size and cost.

The paper sensor device 2 is capable of measurement with high precision even when the sheet of paper P is being transported. The configuration can therefore reduce printing time taken from a print command input by the user to actual printing over cases where the sheet of paper P needs to be stopped for measurement.

### Variation Example 1

The light-emitter 3 is embedded in the transport roller 5 in Embodiment 1 described above. Alternatively, the photodetector 4 may be embedded in the transport roller 5. The light-emitter 3 generates heat and may be disposed on the paper guide 6 for better heat dissipation.

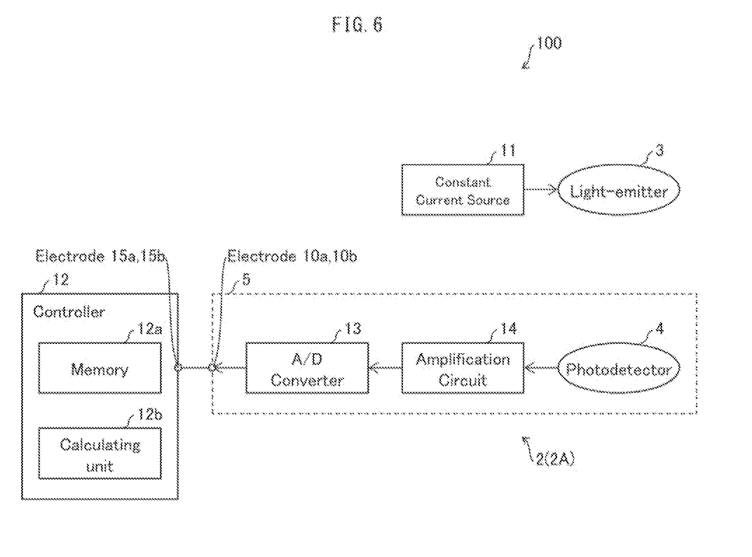

Attention should be paid to the fact that the photodetector 4 itself can only produce a very low output current, which is susceptible to noise. Therefore, if the photodetector 4 is embedded in the transport roller 5, it is preferable that the amplification circuit 14 and the A/D converter 13 as well as the photodetector 4 be embedded in the transport roller 5, as shown in FIG. 6, to enable the output of measurements in the form of digital signals. FIG. 6 is a block diagram of a configuration of major components of the image-forming device 100 in accordance with Variation Example 1.

In this configuration, the roller electrodes 10a, 10b, disposed at or near the ends of the transport roller 5, are again maintained in contact with the external electrodes 15a, 15b even when the transport roller 5 is rotating. This structure enables the external supply of power to the amplification circuit 14 and the A/D converter 13 and the external extraction of digital signals from the A/D converter 13. The external electrodes 15a, 15b are connected to the controller 12 in this example.

Two pairs of electrodes do not need to be provided between the transport roller 5 and the controller 12 in the same configuration. There may be provided power sources for the amplification circuit 14 and the A/D converter 13 and electrodes for the output of the digital signals.

The output of the A/D converter 13 may be transmitted to the outside of the transport roller 5 in a contactless manner by electromagnetic waves in the configuration. More specifically, there may be additionally provided an electromagnetic wave transmitter embedded in the transport roller 5 and an electromagnetic wave receiver disposed outside the transport roller 5. This structure enables the output of the A/D converter 13 to be transmitted to the outside of the transport roller 5 by the transmitter and received by the receiver disposed outside the transport roller 5 for further transmission to the controller 12.

Conversely, there may be provided an electromagnetic wave receiver embedded inside the transport roller 5 and an electromagnetic wave transmitter disposed outside the transport roller 5. This structure enables reception of measurement timings and user commands via electromagnetic waves.

This use of a transmitter and a receiver enables contactless communications with elements embedded in the transport roller 5. That in turn eliminates high contact resistance and improper contacts that could be caused, for example, by dirt and grime between the roller electrodes 10a, 10b and the external electrodes 15a, 15b.

### Variation Example 2

Drive current is supplied to the light-emitter 3 embedded in the transport roller 5, in Embodiment 1 described above, by disposing the roller electrodes 10a, 10b in contact with the external electrodes 15a, 15b connected to the constant current source 11. Alternatively, there may be provided a coil embedded in the transport roller 5 and an AC magnetic field generator outside the transport roller 5. In this structure, the external AC magnetic field electromagnetically induces voltage across the coil inside the transport roller 5. This voltage is rectified and used to drive the light-emitter 3. It is preferable in this structure that the constant current source 11 be also disposed inside the transport roller 5 to drive the light-emitter 3 with a constant current.

This structure again enables contactless supply of power. That eliminates high contact resistance and improper contacts that could be caused, for example, by dirt and grime between the roller electrodes 10a, 10b and the external electrodes 15a, 15b.

### Embodiment 2

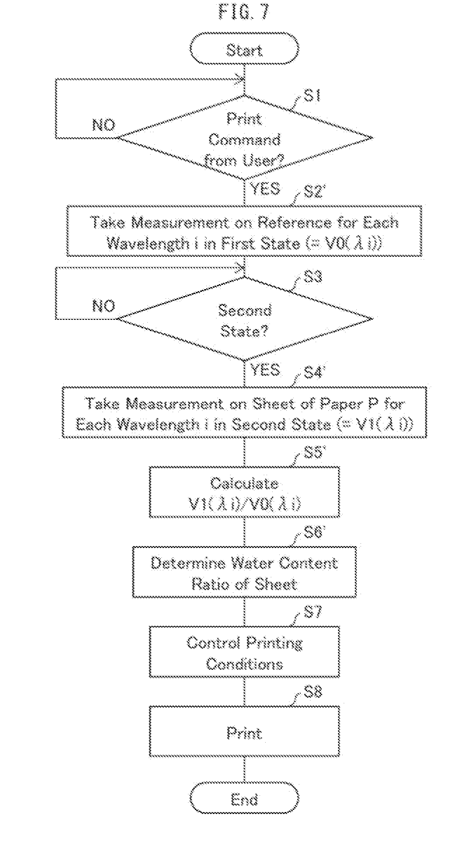

The following will describe another embodiment of the present disclosure in reference to FIG. 7. For convenience of description, members of the present embodiment that have the same function as members of the previous embodiment are indicated by the same reference numerals, and description thereof is omitted.

The light-emitter 3 in the paper sensor device 2A in accordance with the present embodiment (see FIGS. 1 and 3) includes a plurality of light sources of different wavelengths (“n” light sources; n≥2). The controller 12 selectively turns on one of these light sources in the light-emitter 3 at a time to control wavelength. This arrangement enables, for example, selective output of an absorption peak wavelength for water over other wavelengths. That in turn makes it possible to determine the water content ratio of the sheet of paper P as a paper property.

There are provided a pair of roller electrodes 10a, 10b and a pair of external electrodes 15a, 15b connected to the constant current source 11 in Embodiment 1 described above. In contrast, in the present embodiment, there are provided n+1 roller electrodes (not shown), one for grounding and n for current supply to the respective light sources. The same applies to the external electrodes connected to the constant current source 11. Alternatively, there may be provided a plurality of roller electrodes, two for power supply and the rest for signals for controlling turning on/off of the light sources. The same applies to the external electrodes connected to the constant current source 11. In the latter structure, one of the light sources can be selectively turned on via the control signal in the transport roller 5.

There may be provided the same number of constant current sources 11 as the light sources so that the controller 12 can selectively turn on/off one of the light sources. Alternatively, there may be provided a single constant current source 11 the output current of which is fed to one of the light sources selected by a switch controllable by the controller 12, to control wavelength for the light-emitter 3.

Next, referring to FIG. 7, a description will be given of a printing process in which the water content ratio of a sheet of paper is determined as a paper property and an image is printed in accordance with a result of the determination. FIG. 7 is a flow chart for a printing process in the image-forming device 100A (see FIG. 17) in accordance with the present embodiment.

In FIG. 7, steps S2′ and S4′ to S6′ replace steps S2 and S4 to S6 in the flow chart in FIG. 5, which is a difference from the image-forming device 100 in accordance with Embodiment 1.

Reference V0(λi) is measured in step S2′ for each wavelength i (i=1,2, . . . , and n) in the first state. Specifically, first, only a first one of the light sources is turned on, and the resultant output V0(λ1) of the A/D converter 13 is stored in the memory 12a of the controller 12. Next, the first light source is turned off. A second one of the light sources is then turned on, and the resultant output V0(λ2) of the A/D converter 13 is stored in the memory 12a of the controller 12. V0(λ3) and subsequent voltages are similarly stored in the memory 12a of the controller 12.

In step S4′, as the second state is reached, and measurement values V1(λ1), V1(λ2), . . . , and V1(λn) obtained by measurement on the sheet of paper P are similarly stored in the memory 12a. In step S5′, the calculating unit 12b of the controller 12 retrieves V0(λ1), V0(λ2), . . . , and V0(λn) and V1(λ1), V1(λ2), . . . , and V1(λn) from the memory 12a and calculates V1(λi)/V0(λi) for each wavelength i. The memory 12a of the controller 12 stores a relationship between V1(λi)/V0(λi) and water content ratio, for example, in the form of table or mathematical expression in advance on the basis of measurements of water content ratios of various sheets of paper P. This database is used in step S6′ to determine the water content ratio of the sheet of paper P.

In the description above, the water content ratio is calculated through selective output of an absorption peak wavelength for water over other wavelengths. Parameters other than water content ratio may be used. The thickness, grammage, surface smoothness, and other properties of the sheet of paper P can be detected using the paper sensor device 2A by selecting a proper wavelength.

The image-forming device 100A specifies image-forming conditions in step S7 in accordance with a result of the calculation in S6′ and in step S8 forms an image on the sheet of paper P. If the sheet of paper P has a high water content, the controller 12 reduces transfer current over cases where the sheet of paper P has a low water content.

### Embodiment 3

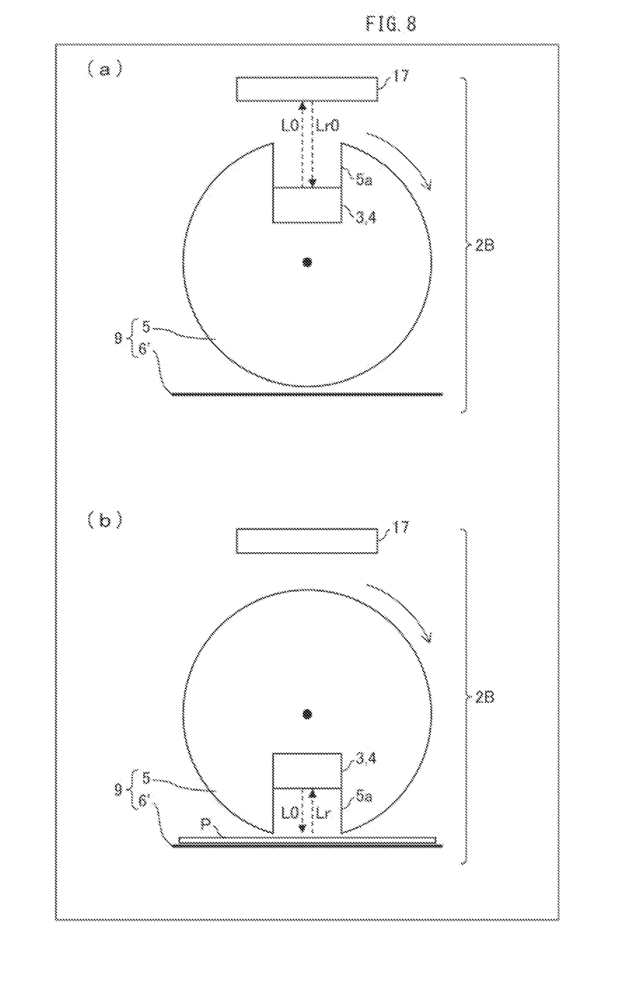

The following will describe another embodiment of the present disclosure in reference to FIGS. 8 to 10. For convenience of description, members of the present embodiment that have the same function as members of any of the previous embodiments are indicated by the same reference numerals, and description thereof is omitted. Measurement is made on transmitted light in Embodiments 1 and 2, whereas measurement is made on reflected light in the present embodiment.

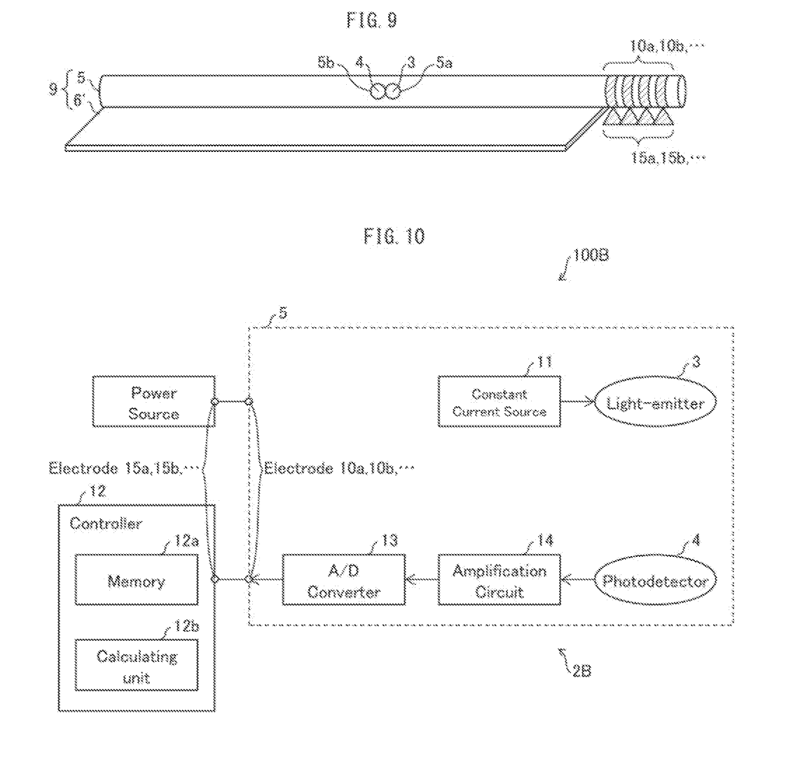

FIG. 8 is a schematic illustration of the paper sensor device 2B in accordance with the present embodiment, (a) and (b) of FIG. 8 representing the first and second states of the paper sensor device 2B respectively. FIG. 9 is a schematic perspective view of the paper sensor device 2B.

As shown in (a) and (b) of FIG. 8 and FIG. 9, the paper sensor device 2B includes the light-emitter 3 and the photodetector 4 both disposed in the transport roller 5. The paper sensor device 2B further includes a reflector (reflecting body) 17 outside the transport roller 5 in a direction that differs from the direction in which the light-emitter 3 and the photodetector 4 faces the sheet of paper P. The reflector 17 is used to measure reference light (reference). The light-emitter 3 projects light onto the reflector 17, and its reflection is received by the photodetector 4. In the example of FIG. 8, the reflector 17 is disposed opposite the transport roller 5 from a paper guide 6′.

The photodetector 4 is disposed so as to be capable of receiving reflection of emission light L0. More particularly, a hole 5b is provided adjacent to the hole 5a in the transport roller 5 as shown in FIG. 9. The hole 5b extends from the outer circumferential surface of the transport roller 5 toward its center and contains the photodetector 4 embedded therein. FIG. 9 shows the light-emitter 3 and the photodetector 4 next to each other When traced along the rotation axis of the transport roller 5. The light-emitter 3 and the photodetector 4 may be combined into a single unit to be disposed in a single hole. The paper guide 6′ has no window (opening) 7 in the present embodiment. Alternatively, a window (opening) 7 may be formed in the paper guide 6′ to enable additional light-emitters and photodetectors to be embedded, so that many more paper properties can be measured (e.g., the water content and thickness of a sheet of paper can be simultaneously measured).

As shown in (a) of FIG. 8, in the first state, emission light L0 is reflected by the reflector 17, producing reflected light Lr0 received by the photodetector 4. Referring next to (b) of FIG. 8, emission light L0 is reflected, absorbed, or scattered by the sheet of paper P in the second state, producing reflected light Lr striking the photodetector 4. The photodetector 4 receives reflected light Lr0 from the reflector 17 in the first state and receives reflected light Lr from the sheet of paper P in the second state.

Referring to FIG. 9, the roller electrodes 10a, 10b, . . . are disposed at or near the ends of the transport roller 5 in such a manner that the roller electrodes 10a, 10b, . . . are in contact with the external electrodes 15a, 15b, . . . respectively. These electrodes are used to supply power and output measurements.

FIG. 10 is a block diagram of a configuration of major components of the image-forming device 100B. Referring to FIG. 10, the amplification circuit 14 and the A/D converter 13 as well as the photodetector 4 are embedded in the transport roller 5 in the image-forming device 100B as in Variation Example 1 of Embodiment 1. This structure is capable of high precision measurement with low noise.

In the first state, the paper sensor device 2B, configured in this manner, measures reflected light Lr0 coming from the reflector 17 and uses a resultant A/D converter output as V0. In contrast, in the second state, the paper sensor device 2B measures reflected light Lr coming from the sheet of paper P and uses a resultant A/D converter output as V1.

The light-emitter 3 and the photodetector 4 in this example are disposed next to each other when traced along the rotation axis of the transport roller 5 (perpendicular to the page of FIG. 8). This is however a mere example, and other positional relationships are also possible. The positional relationship of the light-emitter 3 and the photodetector 4 may be designed in a suitable manner by selecting such a structure, measurement position, and timing that the photodetector 4 can receive emission light L0 projected onto the reflector 17 or the sheet of paper P as reflected light Lr0 or Lr with high precision.

The reflector 17 in this example is described as being located opposite the transport roller 5 from the paper guide 6′. The reflector 17 however needs only to be disposed in such a location outside the transport path of the sheet of paper P that the reflector 17 can face the light-emitter 3 and the photodetector 4 embedded in the transport roller 5.

### Advantages

Embodiment 3 achieves similar advantages to those achieved by Embodiment 1.

In the structure of Patent Document 2, a sheet of paper comes into contact with a reflecting portion (measuring portion) of the bottom face of the pressing plate. The reflecting portion therefore quickly collects dirt and grime. A dirty reflecting portion will lead to a variation in reference reflectance and may cause an error in the measurement made on the sheet of paper.

In contrast, in the present embodiment, the light-emitter 3 and the photodetector 4 are rotated together with the transport roller 5. This structure allows the reflector 17 to be disposed in a location where the sheet of paper P does not pass, which renders the reflector 17 less likely to collect paper powder, toner, and other undesirable objects than a reflector 17 disposed in the transport path of the sheet of paper P. The reference can hence be measured with high precision, which in turn improves the precision of measurement made on the sheet of paper.

If the arrangements described earlier in Variation Examples 1 and 2 of Embodiment 1 are adopted in a suitable manner in the structure in which measurement is made on reflected light as described in the present embodiment, similar advantages are achieved.

### Embodiment 4

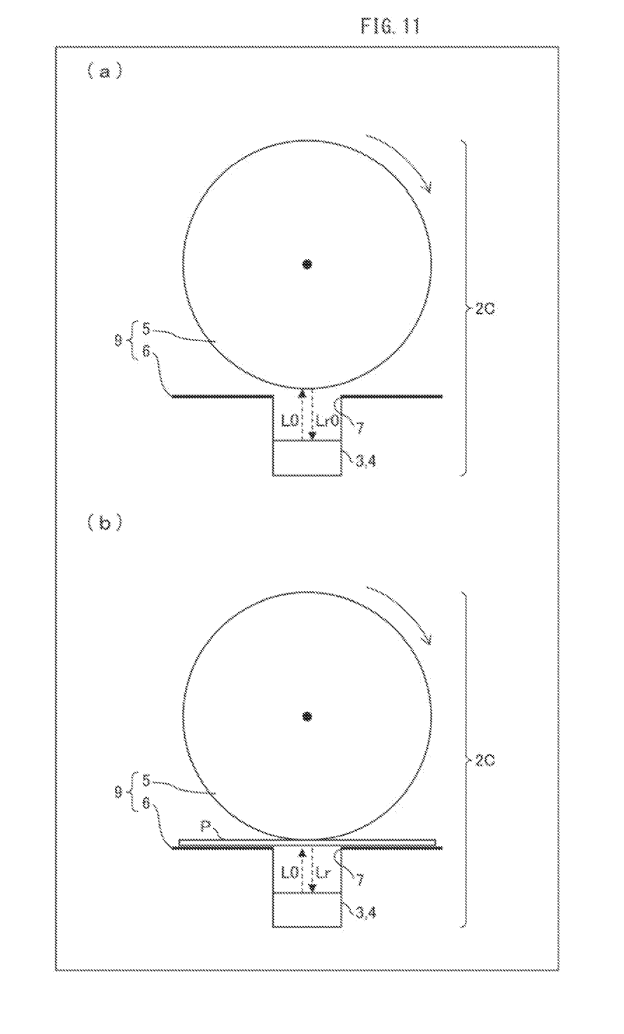

The following will describe another embodiment of the present disclosure in reference to FIG. 11. For convenience of description, members of the present embodiment that have the same function as members of any of the previous embodiments are indicated by the same reference numerals, and description thereof is omitted. The light-emitter 3 and the photodetector 4 are disposed on the back of the paper guide 6′, and the transport roller 5 serves also as a replacement for the reflector (reflecting body) 17, in the present embodiment.

FIG. 11 is a schematic illustration of the paper sensor device 2C in accordance with the present embodiment, (a) and (b) of FIG. 11 representing the first and second states of the paper sensor device 2C respectively. As shown in (a) and (b) of FIG. 11, the paper sensor device 2C includes the light-emitter 3 and the photodetector 4 both disposed on the back of the paper guide 6 which has the window 7. The paper sensor device 2C uses the transport roller 5 as the reflector 17.

As shown in (a) of FIG. 11, in the first state, emission light L0 is reflected by the transport roller 5, producing reflected light Lr0 received by the photodetector 4. Referring next to (b) of FIG. 11, emission light L0 is reflected, absorbed, or scattered by the sheet of paper P in the second state, producing reflected light Lr striking the photodetector 4. The photodetector 4 receives reflected light Lr0 from the transport roller 5 in the first state and receives reflected light Lr from the sheet of paper P in the second state.

The image-forming device 1000 in accordance with the present embodiment includes such a paper sensor device 2C. The image-forming device 100C determines a paper property by the same method and prints by the same printing process as in Embodiment 3, and description thereof is omitted.

### Advantages

This structure eliminates the need to separately provide the reflector 17, which reduces the number of components. The structure also makes it unnecessary to transfer electric power and signals from the transport roller 5 to the outside or vice versa. That in turn obviates the need for the roller electrodes 10a, 10b, the external electrodes 15a, 15b, and other special arrangements described in Variation Examples 1 and 2 of Embodiment 1 for electrically connecting elements in the transport roller 5 to the outside.

### Embodiment 5

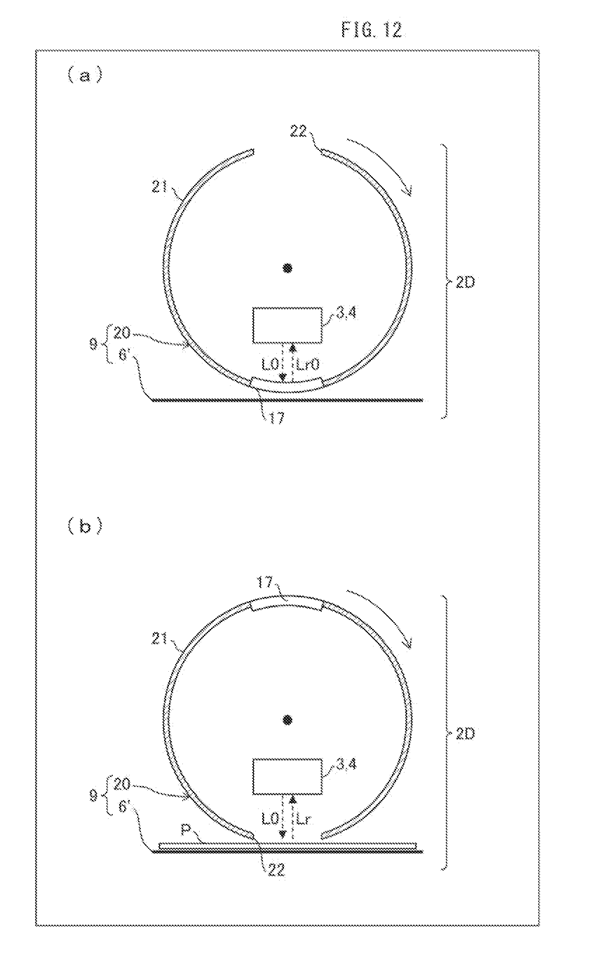

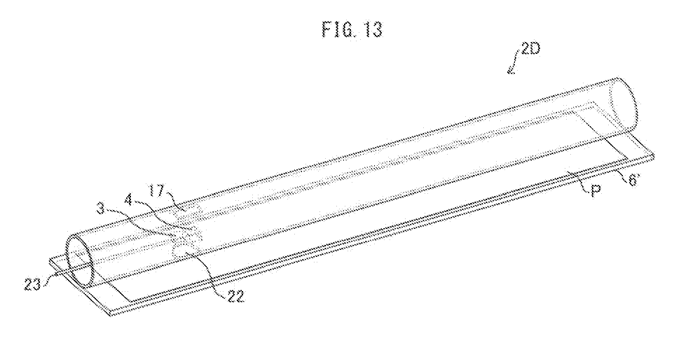

The following will describe another embodiment of the present disclosure in reference to FIGS. 12 and 13. For convenience of description, members of the present embodiment that have the same function as members of any of the previous embodiments are indicated by the same reference numerals, and description thereof is omitted. The transporting unit 9 in the present embodiment includes a hollow transport roller 20 that includes a cylindrical rotator 21 having an outer circumferential surface serving as a sandwiching face.

FIG. 12 is a schematic illustration of the paper sensor device 2D in accordance with the present embodiment, (a) and (b) of FIG. 12 representing the first and second states of the paper sensor device 2D respectively. FIG. 13 is a schematic perspective view of the transporting unit 9 in the paper sensor device 2D.

As shown in (a) and (b) of FIG. 12, in the transporting unit 9 in the paper sensor device 2D, the transport roller 20 includes the cylindrical rotator 21 having an outer circumferential surface serving as a sandwiching face. The cylindrical rotator 21 is driven to rotate in the transporting unit 9. This rotation transports the sheet of paper P sandwiched between the cylindrical rotator 21 and the paper guide 6′. The cylindrical rotator 21 in the transport roller 20 is lifted and lowered by a moving mechanism (not shown) between an upper, retracted position and a lower, transport position. When the sheet of paper P is yet to reach the gap between the cylindrical rotator 21 and the paper guide 6′, the cylindrical rotator 21 is separated from the paper guide 6′. As the sheet of paper P reaches the gap between the cylindrical rotator 21 and the paper guide 6′, the cylindrical rotator 21 is lowered to transport the sheet of paper P sandwiched between the cylindrical rotator 21 and the paper guide 6′.

The light-emitter 3 and the photodetector 4 are disposed in the cylindrical rotator 21 in such a manner as not to rotate with the cylindrical rotator 21. Specifically, the light-emitter 3 and the photodetector 4 are fixed to a supporting unit 23 inserted in the cylindrical rotator 21 as shown in FIG. 13. The supporting unit 23 fixes and supports the light-emitter 3 and the photodetector 4 and includes conductive wires that transmit drive current to the light-emitter 3 and output signals from the photodetector 4.

The cylindrical rotator 21 has a window 22 formed and includes a reflector 17 formed on the inner circumferential surface thereof. Similarly to the window 7, the window 22 needs only to transmit the wavelengths of the light emitted by the light-emitter 3. The window 22 may be either a mere hole formed in the cylindrical rotator 21 or a hole fitted with glass or a like transparent member.

As shown in (a) of FIG. 12, in the first state, emission light L0 is reflected by the reflector 17, producing reflected light Lr0 received by the photodetector 4. Referring next to (b) of FIG. 12, emission light L0 is reflected, absorbed, or scattered by the sheet of paper P in the second state, producing reflected light Lr striking the photodetector 4. The photodetector 4 receives reflected light Lr0 from the reflector 17 in the first state and receives reflected light Lr from the sheet of paper P in the second state.

The image-forming device 100D in accordance with the present embodiment includes such a paper sensor device 2D. The image-forming device 100D determines a paper property by the same method and prints by the same printing process as in Embodiment 3, and description thereof is omitted.

### Advantages

This structure isolates the reflector 17 not only from the transport path of the sheet of paper P, but also from the internal space of the image-forming device 100D, which in turn can effectively prevent the reflector 17 from collecting dirt and grime. The structure also makes it unnecessary to transfer electric power and signals from the transport roller 5 to the outside or vice versa. That in turn obviates the need for the roller electrodes 10a, 10b, the external electrodes 15a, 15b, and other special arrangements described in Variation Examples 1 and 2 of Embodiment 1 for electrically connecting elements in the transport roller 5 to the outside.

### Embodiment 6

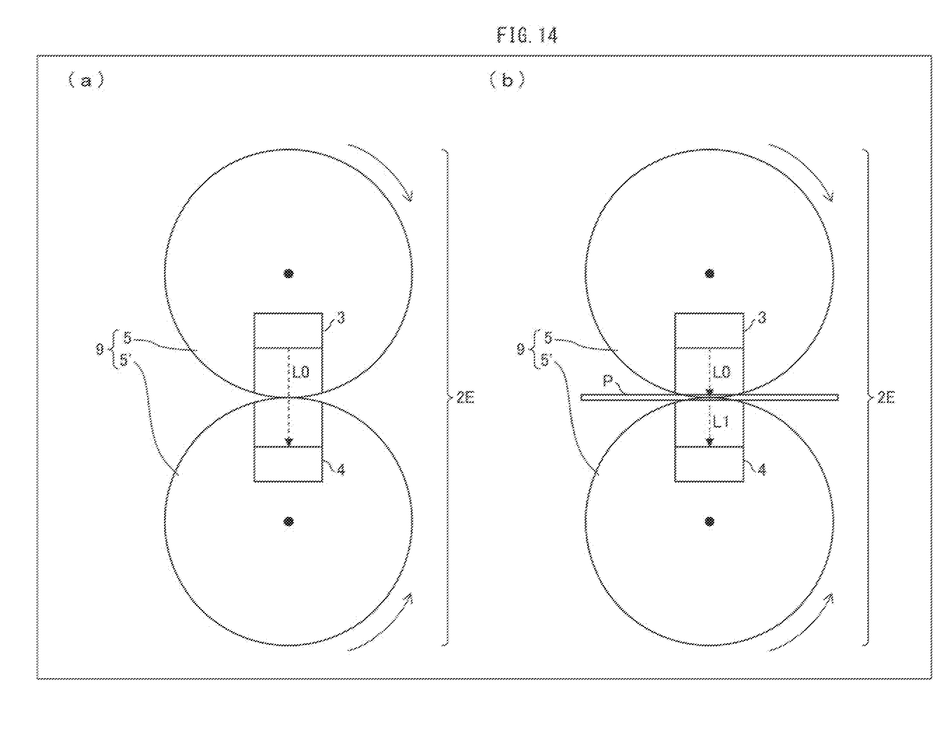

The following will describe another embodiment of the present disclosure in reference to FIGS. 14 to 16. For convenience of description, members of the present embodiment that have the same function as members of any of the previous embodiments are indicated by the same reference numerals, and description thereof is omitted.

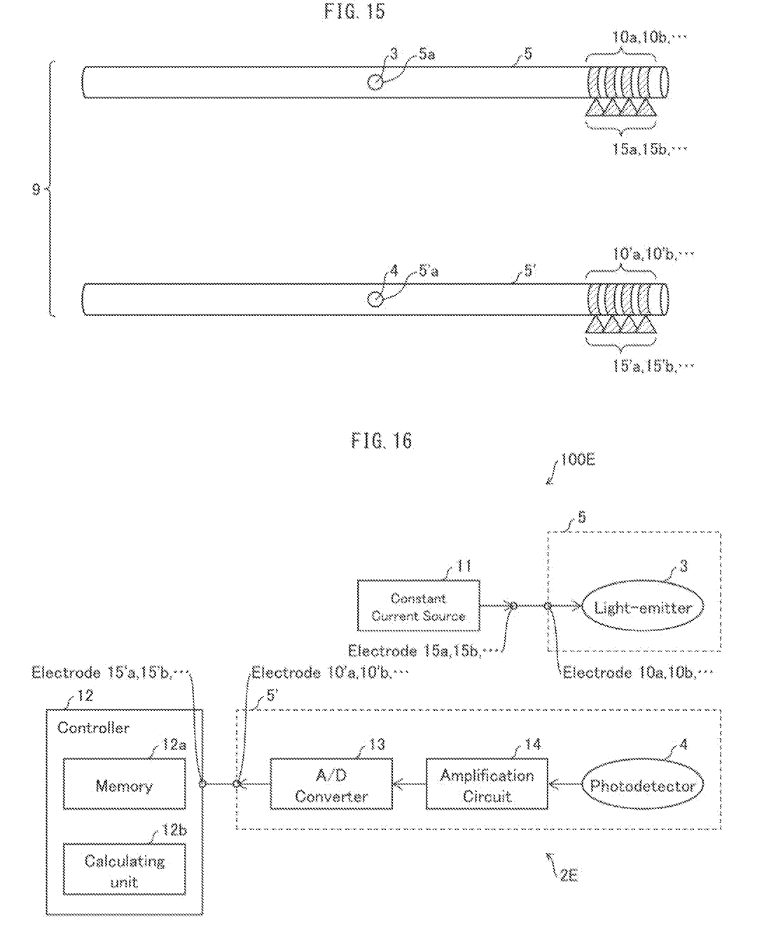

FIG. 14 is a schematic illustration of the paper sensor device 2E in accordance with the present embodiment, (a) and (b) of FIG. 14 representing the first and second states of the paper sensor device 2E respectively. FIG. 15 is a schematic perspective view of two transport rollers 5, 5′ provided in the transporting unit 9 in the paper sensor device 2E. FIG. 16 is a block diagram of a configuration of major components of the image-forming device 100.

As shown in (a) and (b) of FIG. 14 and FIG. 15, the transporting unit 9 in the paper sensor device 2E includes the transport roller (second transport roller) 5′ in place of the paper guide 6 in the paper sensor device 2 in accordance with Embodiment 1 shown in FIG. 1. The photodetector 4 is embedded in the transport roller 5′. Specifically, the photodetector 4 is disposed in a hole 5′a formed in the transport roller 5° from its outer circumferential surface toward its center. The photodetector 4 has a light-receiving face directed at the opening (window) of the hole 5′a.

In the transporting unit 9, the transport roller (first transport roller) 5 and the transport roller 5′, which constitute a pair of rollers, rotate to sandwich and transport the sheet of paper P in a nip region where the transport rollers 5, 5′ come in contact with each other. The transport rollers 5, 5′ are structured so that the light-emitter 3 and the photodetector 4 face each other as a result of the rotation of the transport rollers 5, 5′.

Referring to FIG. 15, the transport roller 5′ includes roller electrodes (first electrodes) 10′a, 10′b, . . . disposed at or near its ends, similarly to the transport roller 5. The transport roller 5′ is structured so that external electrodes (second electrodes) 15′a, 15′b, . . . slide respectively on the roller electrodes 10′a, 10′b, . . . . The external electrodes (second electrodes) 15′a, 15′b, . . . are connected to the controller 12 so that the measurements optically obtained by the photodetector 4 can be transmitted.

If the photodetector 4 is embedded in the transport roller 5′, it is preferable to employ any of the configurations described in Variation Examples 1 and 2 of Embodiment 1 as shown in FIG. 16. In the example of FIG. 16, the amplification circuit 14 and the A/D converter 13 are embedded in the transport roller 5′, and the results of the measurement by the photodetector 4 are outputted in the form of digital signals.

The image-forming device 100E in accordance with the present embodiment includes such a paper sensor device 2E. The image-forming device 100E determines a paper property by the same method and prints by the same printing process as in Embodiments 1 and 2, and description thereof is omitted.

### Advantages

In this configuration, measurements are made on the sheet of paper P being sandwiched in the nip region between the transport rollers 5, 5′. The configuration can therefore further reduce adverse effects of flapping, tilting, and warping of the sheet of paper P and take measurements with higher precision.

The transport rollers 5, 5′, as a pair of rollers, may be in contact with each other with a prescribed pressure at all times. This arrangement eliminates the need for lifting and lowering the transport roller 5 (or the transport roller 5′) before and after the sheet of paper P reaches the nip region, thereby rendering it unnecessary to provide a mechanism that lifts and lowers the transport roller 5.

### Variation Example 3

Embodiment 6 described above includes the transport roller 5′ in place of the paper guide 6 provided in the paper sensor device 2 in accordance with Embodiment 1, and the photodetector 4 is embedded in the transport roller 5′. As an alternative example, Embodiment 6 may include the transport roller 5′ in place of the paper guide 6′ provided in the paper sensor device 2B in accordance with Embodiment 3 shown in FIG. 8. As a further alternative, Embodiment 6 may include the transport roller 5′ in place of the paper guide 6 provided in the paper sensor device 2C in accordance with Embodiment 4 shown in FIG. 11, and the light-emitter 3 and the photodetector 4 may be embedded in the transport roller 5′. As yet another alternative, Embodiment 6 may include the transport roller 5′ in place of the paper guide 6′ provided in the paper sensor device 2D in accordance with Embodiment 5 show in FIG. 12.

### SUMMATION

The present disclosure, in aspect 1 thereof, is directed to a paper sensor device including: a light-emitter; a photodetector configured to receive measurement light projected by the light-emitter and then either transmitted or reflected by a sheet of paper, the paper sensor device detecting a paper property based on the measurement light; and a transporting unit configured to transport the sheet of paper while sandwiching the sheet of paper between a transport roller and an opposing member, either or both of the transport roller and the opposing member having a window on a sandwiching face thereof where the sheet of paper is sandwiched, wherein: the light-emitter projects light via the window(s) onto a sandwiched portion of the sheet of paper being transported; and the photodetector receives the measurement light via the window(s).

This structure includes a transporting unit that sandwiches and transports a sheet of paper. The transporting unit includes a transport roller and an opposing member either or both of which has/have a window on a sandwiching face thereof where the sheet of paper is sandwiched. The light-emitter projects light via the window(s) onto a sandwiched portion of the sheet of paper being transported. The photodetector receives via the window(s) the measurement light, which is transmission or reflection of the projected light. In other words, the sandwiched portion of the sheet of paper is used as a measuring portion where a paper property is detected.

The sandwiched portion of the sheet of paper does not flap, tilt, or warp even while being transported. Therefore, a paper property can be detected with high precision based on the measurement light by using the sandwiched portion as the measuring portion.

In aspect 2 of the present disclosure, the paper sensor device of aspect 1 is configured such that the photodetector receives reference light that is produced from light emitted by the light-emitter in a first state and receives the measurement light transmitted or reflected by the sheet of paper in a second state, to detect the paper property based on the measurement light and the reference light.

In this structure, reference light is received that is produced from the tight emitted by the light-emitter. The structure therefore can eliminate, for example, variations of the intensity of the light emitted by the light-emitter in order to detect a paper property with higher precision.

In aspect 3 of the present disclosure, the paper sensor device of aspect 2 is configured such that: the light-emitter and the photodetector are located separately, one inside the transport roller and the other opposite the sandwiching face of the opposing member; and the photodetector, as a result of rotation of the transport roller, faces the light-emitter to receive the reference light emitted by the light-emitter in the first state where there exists no sheet of paper between the light-emitter and the photodetector and to receive the measurement light transmitted by the sheet of paper in the second state where the sheet of paper exists between the light-emitter and the photodetector.

In this structure, the light-emitter and the photodetector are located separately, one inside the transport roller and the other opposite the sandwiching face of the opposing member, The photodetector can still receive both the reference light and the measurement light when the photodetector comes to face the light-emitter as a result of rotation of the transport roller.

In aspect 4 of the present disclosure, the paper sensor device of aspect 2 further includes a reflecting body configured to measure the reference light, wherein: the light-emitter and the photodetector are located together either inside the transport roller or opposite the sandwiching face of the opposing member; and the photodetector receives the reference light reflected by the reflecting body in the first state where the light emitted by the light-emitter is projected onto the reflecting body and receives the measurement light reflected by the sheet of paper in the second state where the light emitted by the light-emitter is projected onto the sheet of paper.

In this structure, the light-emitter and the photodetector are located together either inside the transport roller or opposite the sandwiching face of the opposing member. The photodetector can still receive the reference light when both the photodetector and the light-emitter face the reflecting body and receive the measurement light when both the photodetector and the light-emitter face the sheet of paper.

In aspect 5 of the present disclosure, the paper sensor device of aspect 4 is configured such that the reflecting body is located outside a transport path of the sheet of paper.

In this structure, the reflecting body is located outside a transport path of the sheet of paper. The reflecting body is therefore unlikely to collect paper powder and toner. The structure can restrain measurement precision from falling due to a dirty reflecting body.

In aspect 6 of the present disclosure, the paper sensor device of aspect 4 is configured such that: the light-emitter and the photodetector are located opposite the sandwiching face of the opposing member; and the transport roller doubles as the reflecting body.

In this structure, the transport roller doubles as the reflecting body. That eliminates the need to provide a separate reflecting body, which reduces the number of components.

In aspect 7 of the present disclosure, the paper sensor device of aspect 5 is configured such that: the light-emitter and the photodetector are disposed so as to rotate with the transport roller; and the reflecting body is located on an outer circumference surface of the transport roller in a direction that differs from a direction in which the light-emitter and the photodetector face the sheet of paper.

Using this structure, the reflecting body can be readily located outside a transport path.

In aspect 8 of the present disclosure, the paper sensor device of aspect 5 is configured such that: the transport roller includes a cylindrical rotator having an outer circumferential surface that provides the sandwiching face; the light-emitter and the photodetector are located inside the cylindrical rotator in such a manner that the light-emitter and the photodetector do not rotate with the cylindrical rotator; the cylindrical rotator includes the window(s); and the reflecting body is located on an inner circumferential surface of the cylindrical rotator.

Using this structure, the reflecting body can be readily located outside a transport path. The structure can isolate the reflecting body not only from the transport path of the sheet of paper, but also from the internal space of an image-forming device or a like device in which the paper sensor device is provided. That can effectively prevent the reflecting body from collecting dirt and grime.

In aspect 9 of the present disclosure, the paper sensor device of any one of aspects 1 to 8 is configured such that: the transport roller serves as a first transport roller; and the opposing member serves as a second transport roller that, together with the first transport roller, serves as a pair of rollers.

In this structure, measurements are made on the sheet of paper being sandwiched in the nip region between the first and second transport rollers. The structure can therefore further reduce adverse effects of flapping, tilting, and warping of the sheet of paper and take measurements with higher precision. In addition, if the first and second transport rollers are pressed in contact with each other in a suitable manner, there is no need for a mechanism that lifts and lowers the first transport roller, which is needed if the transporting unit is a paper guide.

In aspect 10 of the present disclosure, the paper sensor device of any one of aspects 1 to 5 and 7 to 9 is configured such that either of the light-emitter and the photodetector is located at least inside the transport roller, the paper sensor device further including: a first electrode on an outer circumferential surface of the transport roller, the first electrode being electrically connected to an element inside the transport roller; and a second electrode outside the transport roller, the second electrode sliding on the first electrode as a result of rotation of the transport roller.

This structure readily enables, for example, the supply of power and the extraction of outputs to/from elements inside the rotating transport roller.

In aspect 11 of the present disclosure, the paper sensor device of any one of aspects 1 to 5 and 7 to 10 is configured such that the light-emitter is located at least inside the transport roller, the paper sensor device further including: a coil inside the transport roller; and an AC magnetic field generator outside the transport roller, wherein an element inside the transport roller operates on electric power generated by an electromotive force electromagnetically induced in the coil by an AC magnetic field generated by the AC magnetic field generator.

This structure eliminates the need to supply power from the outside of e transport roller.

In aspect 12 of the present disclosure, the paper sensor device of any one of aspects 1 to 5 and 7 to 11 is configured such that the photodetector is located at least inside the transport roller, the paper sensor device further including: an electromagnetic wave transmitter inside the transport roller; and an electromagnetic wave receiver outside the transport roller.

This structure enables contactless communications with elements embedded in the transport roller. That can in turn eliminate high contact resistance and improper contacts in configurations in which electrodes are provided in contact with each other.

In aspect 13 of the present disclosure, the paper sensor device of any one of aspects 1 to 5 and 7 to 12 is configured such that the light-emitter is located at least inside the transport roller, the paper sensor device further including: an electromagnetic wave receiver inside the transport roller; and an electromagnetic wave transmitter outside the transport roller.

This structure enables contactless communications with elements embedded in the transport roller. That can in turn eliminate high contact resistance and improper contacts in configurations in which electrodes are provided in contact with each other.

In aspect 14 of the present disclosure, the paper sensor device of any one of aspects 1 to 13 is configured such that the light-emitter includes a plurality of types of light sources having different peak wavelengths.

This structure enables detection of water content ratio and other paper properties.

In aspect 15 of the present disclosure, the paper sensor device of any one of aspects 1 to 14 is configured such that the light-emitter and the photodetector measure the measurement light at least at two portions of each sheet of paper.

This structure enables high precision detection of a paper property even in the presence of variations in a sheet of paper.

In aspect 16 of the present disclosure, the paper sensor device of any one of aspects 1 to 15 is configured such that the paper property includes at least one of a brand name, thickness, grammage, water content ratio, and surface smoothness of the sheet of paper.

The present disclosure, in aspect 17 thereof, is directed to an image-forming device including the paper sensor device of any one of aspects 1 to 16, the image-forming device specifying an image-forming condition based on a result of detection carried out by the paper sensor device.

In aspect 18 of the present disclosure, the image-forming device of aspect 17 is configured such that the image-forming condition is at least one of a voltage level applied across a transfer unit, a current level supplied to the transfer unit, a pressure applied to the sheet of paper by a fuser, a temperature at which the fuser heats the sheet of paper, and a velocity at which the fuser transports the sheet of paper.

The present invention is not limited to the description of the embodiments above and may be altered within the scope of the claims. Embodiments based on a proper combination of technical means disclosed in different embodiments are encompassed in the technical scope of the present invention. Furthermore, a new technological feature may be created by combining different technological means disclosed in the embodiments.

### REFERENCE SIGNS LIST

2, 2A, 2B, 2C, 2D, 2E Paper Sensor Device

3 Light-emitter

4 Photodetector

5, 5′, 20 Transport Roller

6, 6′ Paper Guide (Opposing Member)

9, 9B Transporting unit

7, 22 Window

17 Reflector

10a, 10b Roller Electrode

11 Constant Current Source

12 Controller

12a Memory

12b Calculating unit

13 A/D Converter

14 Amplification Circuit

15a, 15b External Electrode

21 Cylindrical Rotator

23 Supporting unit

100, 100A, 100B, 100D, 100E Image-forming Device

What is claimed is:

1. A paper sensor device comprising:
a light-emitter;
a photodetector configured to receive measurement light projected by the light-emitter and then either transmitted or reflected by a sheet of paper, the paper sensor device detecting a paper property based on the measurement light; and
a transporting unit configured to transport the sheet of paper while sandwiching the sheet of paper between a transport roller and an opposing member, either or both of the transport roller and the opposing member having a window on a sandwiching face thereof where the sheet of paper is sandwiched, wherein:
the light-emitter projects light via the window(s) onto a sandwiched portion of the sheet of paper being transported; and
the photodetector receives the measurement window(s).

2. The paper sensor device according to claim 1, wherein the photodetector receives reference light that is produced from light emitted by the light-emitter in a first state and receives the measurement light transmitted or reflected by the sheet of paper in a second state, to detect the paper property based on the measurement light and the reference light.

3. The paper sensor device according to claim 2, wherein:
the light-emitter and the photodetector are located separately, one inside the transport roller and the other opposite the sandwiching face of the opposing member; and
the photodetector, as a result of rotation of the transport roller, faces the light-emitter to receive the reference light emitted by the light-emitter in the first state where there exists no sheet of paper between the light-emitter and the photodetector and to receive the measurement light transmitted by the sheet of paper in the second state where the sheet of paper exists between the light-emitter and the photodetector.

4. The paper sensor device according to claim 2 further comprising a reflecting body configured to measure the reference light, wherein:
the light-emitter and the photodetector are located together either inside the transport roller or opposite the sandwiching face of the opposing member; and
the photodetector receives the reference light reflected by the reflecting body in the first state where the light emitted by the light-emitter is projected onto the reflecting body and receives the measurement light reflected by the sheet of paper in the second state Where the light emitted by the light-emitter is projected onto the sheet of paper.

5. The paper sensor device according to claim 4, wherein the reflecting body is located outside a transport path of the sheet of paper.

6. The paper sensor device according to claim 4, wherein:
the light-emitter and the photodetector are located opposite the sandwiching face of the opposing member; and
the transport roller doubles as the reflecting body.

7. The paper sensor device according to claim 5, wherein:
the light-emitter and the photodetector are disposed so as to rotate with the transport roller; and
the reflecting body is located on an outer circumference surface of the transport roller in a direction that differs from a direction in which the light-emitter and the photodetector face the sheet of paper.

8. The paper sensor device according to claim 5, wherein:
the transport roller includes a cylindrical rotator having an outer circumferential surface that provides the sandwiching face;
the light-emitter and the photodetector are located inside the cylindrical rotator in such a manner that the light-emitter and the photodetector do not rotate with the cylindrical rotator;
the cylindrical rotator includes the window(s); and
the reflecting body is located on an inner circumferential surface of the cylindrical rotator.

9. The paper sensor device according to claim 1, wherein:
the transport roller serves as a first transport roller; and
the opposing member serves as a second transport roller that, together with the first transport roller, serves as a pair of rollers.

10. The paper sensor device according to claim 1, wherein either of the light-emitter and the photodetector is located at least inside the transport roller, the paper sensor device further comprising:
a first electrode on an outer circumferential surface of the transport roller, the first electrode being electrically connected to an element inside the transport roller; and
a second electrode outside the transport roller, the second electrode sliding on the first electrode as a result of rotation of the transport roller.

11. The paper sensor device according to claim 1, wherein the light-emitter is located at least inside the transport roller, the paper sensor device further comprising:
a coil inside the transport roller; and
an AC magnetic field generator outside the transport roller, wherein
an element inside the transport roller operates on electric power generated by an electromotive force electromagnetically induced in the coil by an AC magnetic field generated by the AC magnetic field generator.

12. The paper sensor device according to claim 1, wherein the photodetector is located at least inside the transport roller, the paper sensor device further comprising:
an electromagnetic wave transmitter inside the transport roller; and
an electromagnetic wave receiver outside the transport roller.

13. The paper sensor device according to claim 1, wherein the light-emitter is located at least inside the transport roller, the paper sensor device further comprising:
an electromagnetic wave receiver inside the transport roller; and
an electromagnetic wave transmitter outside the transport roller.

14. The paper sensor device according to claim 1, wherein the light-emitter includes a plurality of types of light sources having different peak wavelengths.

15. The paper sensor device according to claim 1, wherein the light-emitter and the photodetector measure the measurement light at least at two portions of each sheet of paper.

16. The paper sensor device according to claim 1, wherein the paper property includes at least one of a brand name, thickness, grammage, water content ratio, and surface smoothness of the sheet of paper.

17. An image-forming device comprising the paper sensor device according to claim 1, the image-forming device specifying an image-forming condition based on a result of detection carried out by the paper sensor device.

18. The image-forming device according to claim 17, wherein the image-forming condition is at least one of a voltage level applied across a transfer unit, a current level supplied to the transfer unit, a pressure applied to the sheet of paper by a fuser, a temperature at which the fuser heats the sheet of paper, and a velocity at which the fuser transports the sheet of paper.
